(19) United States
(12) Patent Application Publication
(10) Pub. No.: US 2008/0138695 A1
(43) Pub. Date: Jun. 12, 2008

(54) Fuel Cell

(75) Inventors: Haruyuki Nakanishi, Shizuoka-ken (JP); Shigeaki Murata, Shizuoka-ken (JP); Masahiro Imanishi, Shizuoka-ken (JP); Yoshihisa Tamura, Shizuoka-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota (JP)

(21) Appl. No.: 11/795,872

(22) PCT Filed: Feb. 3, 2006
(86) PCT No.: PCT/JP06/02309

§ 371 Date: Sep. 10, 2007

(30) Foreign Application Priority Data
Feb. 4, 2005 (JP) 2005-028468

(51) Int. Cl. H01M 8/02; H01M 8/24

(52) U.S. Cl. 429/35; 429/34

(57) ABSTRACT

A fuel cell comprising cell module assemblies connected in series, each of which gathers two or more cell modules comprising a hollow electrolyte membrane in which an electrode is disposed on a bore side and a shell side thereof respectively, wherein each cell module assembly comprises: a cell module array in which two or more cell modules are aligned in parallel; a partition which separates a space outside of the cell module between the open end and a body of the cell module; a bore side gas passage and a shell side gas passage provided by the partition; a current collector for positive electrode provided in the vicinity of one end of the cell module in the cell module array so that the current collector for positive electrode integrally collects power from each current collector on the positive electrode side of each cell module; a current collector for negative electrode provided in the vicinity of the other end so that the current collector for negative electrode integrally collects power from each current collector on the negative electrode side of each cell module; and a positive or negative electrode output connected with the current collector for positive or negative electrode and provided on a contacting surface of an adjacent cell module assembly; and wherein cell module assemblies are attached having the current collector of the same pole in the same direction, in which, as for adjacent cell module assemblies, the positive electrode output is arranged on the contacting surface of one cell module assembly and the negative electrode output is arranged on the contacting surface of the other cell module assembly, and the cell module assemblies are connected in series.

### TECHNICAL FIELD

The present invention relates to a fuel cell containing a cell module assembly wherein two or more cell modules respectively having a hollow-form electrolyte membrane are integrally fixed.

### BACKGROUND ART

A fuel cell feeds two electrodes electrically connected to each other with a fuel and an oxidant respectively to cause electrochemical oxidation of the fuel so that the chemical energy is directly converted into electrical energy. Since it is not restricted within the Carnot cycle in contrast with the thermal power generation, high conversion efficiency of energy is exhibited. A solid polymer electrolyte fuel cell which is a fuel cell using a solid polymer electrolyte membrane as an electrolyte has advantages such as being easy in size reduction or operative at a low temperature, hence it attracts interests in application to power sources for portable or movable articles.

In the solid polymer electrolyte fuel cell, an anode runs a reaction of EQUATION (1) if hydrogen is used as the fuel.

H₂→2H⁺+2e⁻ EQUATION (1)

Electrons generated in the EQUATION (1) flow through an external circuit to work for an external load, and thereafter reach a cathode. Protons generated in the EQUATION (1) are hydrated with water and move from the anode side, through the solid polymer electrolyte membrane, to the cathode side by electroosmosis while the protons are in the hydrated state.

On the other hand, the cathode runs a reaction of EQUATION (2) if oxygen is used as the oxidant.

2H⁺+(½)O₂+2e⁻→H₂O EQUATION (2)

Water generated at the cathode mainly passes through a gas diffusion layer, and be exhausted outside.

Thus, the fuel cell exhausts no product except water, and it is a clean equipment for power generating.

A conventional solid polymer electrolyte fuel cell, which has mainly been developed, is one having a fuel cell stack obtained by stacking plurality of plane type cell units wherein the plane type cell unit is produced by disposing catalyst layers to be an anode and a cathode on one surface and the other surface of a plane-like shaped solid polymer electrolyte membrane respectively, further disposing gas diffusion layers on both sides of an obtained plane-like shaped membrane electrode assembly respectively, then interposing it between plane-like shaped separators.

In order to improve power density of the solid polymer electrolyte fuel cell, a proton conductive polymer membrane with a very thin membrane thickness is used as the solid polymer electrolyte membrane. Its membrane thickness is often 100 μm or less, and though a further thin electrolyte membrane is used for improvement of power density, a thickness of the cell unit can not extremely be reduced beyond conventional ones. Similarly, a catalyst layer, a gas diffusion layer, separator or the like are also undergoing their thickness reduction. However, improvement of power density per unit volume is limited even by the thickness reduction of all parts. Therefore, it is presumed that, in the future, the needs of further size reduction cannot be satisfied.

As the separator mentioned above, a sheet-like form carbon material which is excellent in corrosion resistance is generally used. The carbon material is expensive itself. In addition, a surface of the separator is often subject to a fine work for forming grooves to be a gas channel in order to evenly supply the fuel gas and the oxidant gas over entire face of the plane-like membrane electrode assembly. Hence, the separator becomes too expensive due to such fine work and raises a manufacturing cost of the fuel cell.

In addition to the above described problems, the plane type cell unit has many problems such that a safe sealing of a periphery of plural cell units which are stacked in order not to leak the fuel gas and the oxidant gas from the above mentioned gas channel is technically difficult, and such that the power generation efficiency is lowered due to distortion or deformation of the plane-like membrane electrode assembly.

Recently, a solid polymer electrolyte fuel cell whose basic unit of power generation is a cell module in which electrodes are disposed on a bore side and a shell side of a hollow electrolyte membrane respectively has been developed (see, for example, Japanese Patent Application Laid-open (JP-A) No. Hei 9-223507, JP-A No. 2002-158015, JP-A No. 2002-260685 and JP-A No. 2002-289220).

The fuel cell having such hollow-form cell modules does not need to use a member corresponding to a separator such as one used in plane type. Besides, since power generation is carried out by feeding its bore and shell sides with gases of different kinds respectively, it is not particularly necessary to form gas channels. Therefore, its manufacturing process is estimated to reduce a manufacturing cost. Furthermore, since the cell module has a three dimensional form, it can make specific surface large with respect to a volume compared with a plane type cell unit, thus improvement of an output power density per unit volume can be expected.

In general, the cell module assembly is formed in such a manner that: hollow-form cell modules of an appropriate number are aligned keeping the longitudinal direction of each cell module in parallel and a predetermined distance so that a reactant gas can be supplied evenly and smoothly around the cell modules; the cell modules are fixed integrally; and power collection from anode and cathode respectively of the cell modules is established. One such a cell module assembly or, if required, two or more cell module assemblies are connected in series or parallel and mounted in the fuel cell.

In order to obtain excellent conduction between the cell module assemblies, it is desired to enlarge a contacting area of cell module assemblies in contact, and to simplify structure connecting cell module assemblies.

Also, in the case of connecting the cell modules in series, the cell module assemblies need to be aligned alternatively with respect to the position of positive electrode and negative electrode. Thus, if a dead-end type cell module, in which only one end of the cell module is open, is used, there is a problem that it is necessary to produce two kinds of cell module assemblies having opposite position of positive electrode and negative electrode, or to provide complicated gas passages for supplying reactant gas to inside of the cell modules.

In light of the above-stated conventional problems, a first object of the present invention is to provide a fuel cell which can enlarge a contacting area of cell module assemblies in contact or can simplify structure connecting cell module assemblies when cell module assemblies, which is an assembly of two or more cell modules mainly comprising a hollow-form electrolyte membrane and electrodes provided on the bore side and shell side of the membrane respectively, are connected in series.

A second object of the present invention is to provide a fuel cell which does not require the cell module assemblies to be aligned alternatively with respect to the position of positive electrode and negative electrode even in the case of using the dead-end type cell module besides attaining the above first object.

### DISCLOSURE OF INVENTION

A fuel cell according to the present invention is a fuel cell comprising two or more cell module assemblies attached and connected in series, each of which gathers two or more cell modules, the cell module, having at least one end open, comprising a hollow electrolyte membrane, a pair of electrodes disposed on a bore side and a shell side of the hollow electrolyte membrane and current collectors being in contact with the electrodes in the pair respectively,

wherein each cell module assembly comprises: a cell module array in which two or more cell modules are aligned keeping the longitudinal direction of each cell module in parallel and open ends or closed ends to the same direction; a partition which separates a space outside of the cell module between the open end and a body of the cell module in the cell module array; a bore side gas passage provided on the open end side of the cell module in the cell module array by said partition and connected with each open end of the cell module so that the bore side gas passage circulates a reactant gas into the bore side of each cell module; a shell side gas passage provided on the body side of the cell module in the cell module array by said partition so that the shell side gas passage circulates a reactant gas on the shell side of each cell module; a current collector for positive electrode provided in the vicinity of one end of the cell module in the cell module array so that the current collector for positive electrode integrally collects power from each current collector on the positive electrode side of each cell module, and a current collector for negative electrode provided in the vicinity of the other end so that the current collector for negative electrode integrally collects power from each current collector on the negative electrode side of each cell module; and a positive or negative electrode output connected with the current collector for positive or negative electrode and provided on a contacting surface of an adjacent cell module assembly; and

wherein the cell module assemblies are attached having the current collector of the same pole in the same direction, in which, as for adjacent cell module assemblies, the positive electrode output is arranged on the contacting surface of one cell module assembly and the negative electrode output is arranged on the contacting surface of the other cell module assembly, and the cell module assemblies are connected in series.

In the fuel cell of the present invention, plurality of the cell module assemblies to be adjacently connected in series are electrically connected with each other on the contacting surface with an adjacent cell module assembly so as to enlarge an area for an electrical contact point, be excellent in conduction between the cell module assemblies, and have a simple structure electrically connecting cell module assemblies.

Further, it is able to connect the cell module assemblies in series and in an array keeping positive and negative electrodes to the same direction. Thus, even in the case of using a dead-end type cell module, it is no longer necessary to produce cell module assemblies aligned alternatively with respect to the position of positive electrode and negative electrode, and to provide complicated gas passages.

The fuel cell of the present invention can employ a structure in which each cell module assembly is provided with a flow channel connecting portion which is an opening on the contacting surface with the adjacent cell module assembly, and the flow channel connecting portion connects with that of an adjacent cell module assembly to allow bore side gas passages of cell module assemblies to communicate. At this time, it is preferable to provide a gas sealing material on a periphery of the flow channel connecting portion for ensuring gas sealing properties of the bore side gas passage at the flow channel connecting portion. As the gas sealing material, there may be an o-ring, a convex gasket, an adhesive and so on. Among them, the o-ring is particularly preferable.

The fuel cell of the present invention is capable to ensure a sufficient area for an electrical contact point with adjacent cell module assemblies and excellent in conduction even in the case of employing the structure connecting bore side gas passages of the cell module assemblies to be mounted in the fuel cell and further in the case of providing the gas sealing material such as the o-ring and so on at the connecting portion of the bore side gas passages.

In the case that the positive and/or negative electrode output of the cell module assembly constitutes a pillar structure which bridges an upper end and an lower end of the contacting surface with the adjacent cell module assembly, it is able to enlarge the contact area of the negative electrode output with the positive electrode output between the adjacent cell module assemblies and simultaneously to reinforce a cell module array in the cell module assembly. When the positive and/or negative electrode output employs such a pillar structure, however, a connecting portion with a current collector of an opposite pole needs to be electrically insulated.

Usually, an output terminal conducting current to/from an outside of the fuel cell is disposed at the positive or negative electrode output of the cell module assembly in an end position of the cell module assembles connected in series.

### EFFECT OF THE INVENTION

The fuel cell of the present invention is excellent in conduction between cell module assemblies connected in series so that a large current can be obtained therefrom. The fuel cell is also excellent in productivity and maintenanceability since a structure connecting cell module assemblies can be simplified.

Further, cell module assemblies can be connected in series without being aligned alternatively with respect to the position of positive electrode and negative electrode. Thus, even in the case of using a so-called dead-end type cell module, it is no longer necessary to produce two kinds of cell module assemblies having opposite position of positive electrode and negative electrode, or to provide complicated gas passages. Therefore, the fuel cell of the present invention is excellent in productivity.

### BRIEF DESCRIPTION OF DRAWINGS

In the accompanying drawings,

FIG. 1 is a perspective view of a tubular cell module of the present invention;

FIG. 2 is a sectional view of a tubular cell module shown in FIG. 1;

FIG. 3 is a view showing one embodiment of the fuel cell of the present invention, which is a perspective view of two adjacent cell module assemblies;

FIG. 4 is a view in which the cell module assembly shown in FIG. 3 is observed from a front face side which has a large width (from the side of the negative electrode output 14);

FIG. 5 is a view in which the cell module assembly shown in FIG. 3, in which the negative electrode output 14 is removed therefrom, is observed from a front face side which has a large width;

FIG. 6 is a view in which the two adjacent cell module assemblies shown in FIG. 3 are observed from a side face side which has a small width; and

FIG. 7 is a sectional view of the cell module assembly shown in FIG. 3 along a plane parallel to a side face which has a small width.

The sign in each figure refers to the following:

1: hollow electrolyte membrane (perfluorocarbon sulfonic acid membrane), 2: anode (bore side electrode), 3: cathode (shell side electrode), 4: current collector for negative electrode, 5: current collector for positive electrode, 6: cell module, 7: cell module array, 8: (8A, 8B) partition, 9: (9A, 9B) bore side gas passage, 10: shell side gas passage, 11 (11A, 11B): tubular body portion, 12: current collector for negative electrode, 13: current collector for positive electrode, 14: negative electrode output, 15: positive electrode output, 16: opening, 17: o-ring, 18: insulating material, and 19: output terminal.

### BEST MODE FOR CARRYING OUT THE INVENTION

A fuel cell according to the present invention is a fuel cell comprising two or more cell module assemblies attached and connected in series, each of which gathers two or more cell modules, the cell module, having at least one end open, comprising a hollow electrolyte membrane, a pair of electrodes disposed on a bore side and a shell side of the hollow electrolyte membrane and current collectors being in contact with the electrodes in the pair respectively,

wherein each cell module assembly comprises: a cell module array in which two or more cell modules are aligned keeping the longitudinal direction of each cell module in parallel and open ends or closed ends to the same direction; a partition which separates a space outside of the cell module between the open end and a body of the cell module in the cell module array; a bore side gas passage provided on the open end side of the cell module in the cell module array by said partition and connected with each open end of the cell module so that the bore side gas passage circulates a reactant gas into the bore side of each cell module; a shell side gas passage provided on the body side of the cell module in the cell module array by said partition so that the shell side gas passage circulates a reactant gas on the shell side of each cell module; a current collector for positive electrode provided in the vicinity of one end of the cell module in the cell module array so that the current collector for positive electrode integrally collects power from each current collector on the positive electrode side of each cell module, and a current collector for negative electrode provided in the vicinity of the other end so that the current collector for negative electrode integrally collects power from each current collector on the negative electrode side of each cell module; and a positive or negative electrode output connected with the current collector for positive or negative electrode and provided on the contacting surface with an adjacent cell module assembly; and

wherein the cell module assemblies are attached having the current collector of the same pole in the same direction, in which, as for adjacent cell module assemblies, the positive electrode output is arranged on the contacting surface of one cell module assembly and the negative electrode output is arranged on the contacting surface of the other cell module assembly, and the cell module assemblies are connected in series.

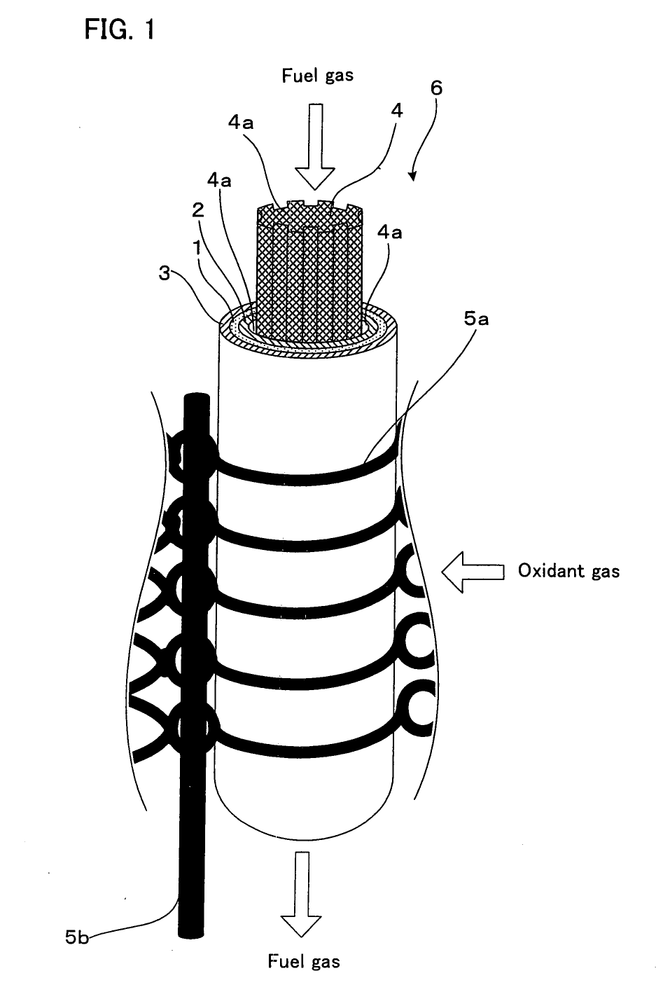

One embodiment of the fuel cell according to the present invention will be described hereafter with reference to FIGS. 1 to 7. Though the embodiment described below will be described mainly based on a solid polymer type fuel cell using hydrogen gas as a fuel and the air (oxygen) as an oxidant, it should be noted that the present invention is not restricted within the embodiment described below.

<Cell Module>

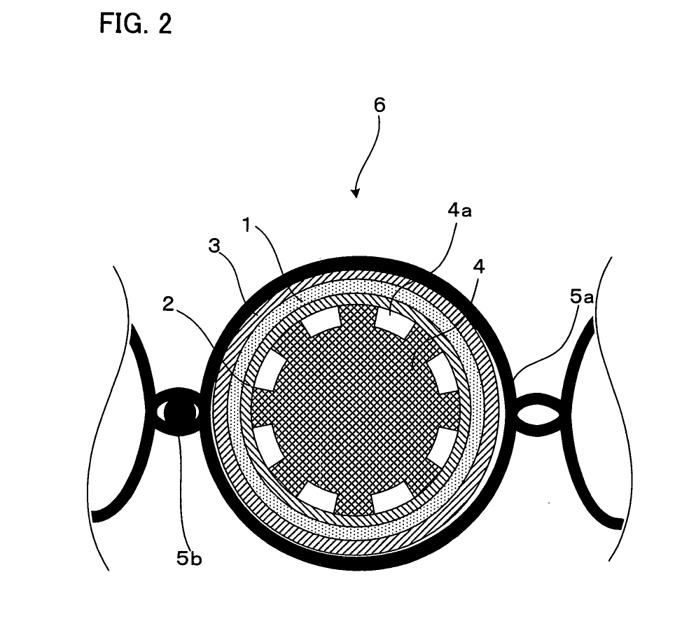

FIG. 1 is a schematic view of a hollow-form cell module which comprises a cell module assembly of the fuel cell of the present invention. FIG. 2 is a sectional view of the hollow-form cell module of FIG. 1. In FIGS. 1 and 2, a cell module 6 has a tubular solid polymer electrolyte membrane (perfluorocarbon sulfonic acid resin membrane) 1, an anode 2 (it is a fuel electrode in this embodiment) disposed on a bore side and a cathode 3 (it is an air electrode in this embodiment) disposed on a shell side of the solid polymer electrolyte membrane 1. Further, a pillar current collector as a current collector for negative electrode 4 is placed on a surface of the anode 2 and a net of a metal wire 5a and a rod-like current collector 5b as current collectors for positive electrode 5 are placed on a surface of the cathode 3.

The hydrogen gas is brought into contact with an inside (substantially, it is a portion exposing to a bore side gas passage formed by a groove 4a provided on a shell side of the current collector for negative electrode 4) of hollow of cell module having such a structure and the air is brought into contact with an outside of the same, thereby a fuel and an oxidant are circulated to the anode and the cathode respectively to generate the power.

A hollow of the cell module 6 of FIG. 1 is opened at both ends thereof and a fuel gas flows into the hollow from one end and flows out from the other end; however, provided that a reactant gas can be sufficiently supplied to an inside of the hollow electrolyte membrane, one end of the hollow may be opened and the other end may be closed. Particularly, as this embodiment, in the case of providing a fuel electrode, which uses hydrogen for fuel, as a bore side electrode, it is possible to completely spend a reactant gas supplied in the hollow since the hydrogen gas which hardly contains non-reactive substance, as a fuel gas, can be supplied to the inside of the hollow of the cell module and the hydrogen gas has a high diffusivity of hydrogen molecule. Thus, the reactant gas can be sufficiently supplied into the hollow though one end thereof is closed. As a method to close one end of the cell module, there may be a method to inject a resin or the like into one end of the hollow, but methods are not particularly limited.

In FIG. 1, the cell module 6 has a tubular electrolyte membrane. However, a hollow electrolyte membrane in the present invention is not limited to a tubular shape, and it may be one having a hollow portion and capable of running the fuel or the oxidant into the hollow to supply a reactant substance necessary for electrochemical reaction to the electrode disposed on a bore side of the hollow.

Though an inside diameter, an outside diameter, a length or the like of the tubular solid polymer electrolyte membrane 1 is not particularly limited, an outside diameter of the tubular electrolyte membrane is preferably in the range of 0.01 to 10 mm, more preferably 0.1 to 1 mm, still more preferably 0.1 to 0.5 mm. A tubular electrolyte membrane with less than 0.01 mm of an outside diameter is difficult to be produced at present due to a technical problem. On the other hand, a tubular electrolyte membrane with more than 10 mm of an outside diameter does not increase a surface area with respect to an occupied volume, hence an obtained cell module may not provide a sufficient output per unit volume.

Though a perfluorocarbon sulfonic acid resin membrane is preferably thin in viewpoint of improving proton conductivity, an extremely thin membrane decreases a function to separate gases and increases a permeating amount of non-proton hydrogen. However, a fuel cell produced by gathering a large number of hollow-shaped cell modules can have a large electrode area in comparison with a conventional fuel cell in which plane type cell units for the fuel cell are stacked, thereby it can provide a sufficient output even if a rather thick membrane is used. To this point, a thickness of the perfluorocarbon sulfonic acid resin membrane is preferably 10 to 100 μm, more preferably 50 to 60 μm, still more preferably 50 to 55 μm.

Further inconsideration of the above described preferable ranges of the outside diameter and the membrane thickness, a preferable range of an inside diameter is 0.01 to 10 mm, more preferably 0.1 to 1 mm, still more preferably 0.1 to 0.5 mm.

Since the fuel cell of the present invention has the hollow-shaped cell module, it can have a large electrode area per unit volume in comparison with a fuel cell having the plane type cell units. Therefore, even if a solid polymer electrolyte membrane to be used is an electrolyte membrane having proton conductivity not as high as that of the perfluorocarbon sulfonic acid resin membrane, a fuel cell having a high power density per unit volume can be obtained. As a solid polymer electrolyte membrane other than the perfluorocarbon sulfonic acid resin, materials used for an electrolyte membrane of the solid polymer type fuel cell can be used, and examples of polymer electrolyte include: fluorocarbon based ion exchange resin other than the perfluorocarbon sulfonic acid resin; polystyrene based cationic exchange membrane having a sulfonic acid group or the like, namely, resins based on a hydrocarbon skeleton such as “polyolefin based” and having at least one kind of proton exchange groups selected from sulfonic acid group, phosphonic acid group, phosphoric acid group or the like; solid polymer electrolytes comprising complex of a basic polymer with a strong acid such as ones disclosed by Japanese translation of PCT international application No. Hei. 11-503262 or the like, namely, ones prepared by doping a strong acid to a basic polymer such as polybenzimidazole, polypyrimidine, polybenzoxazole or the like. A solid polymer electrolyte membrane using such electrolyte may be reinforced with the use of perfluorocarbon polymers of fibril-form, woven fabric-form, nonwoven fabric-form, porous sheet-form or the like, or may also be reinforced by coating a membrane surface with inorganic oxide or metal. Further, the perfluorocarbon sulfonic acid resin membrane is also available from the market, for example, Nafion as trade name of Du pont (the United States of America), Flemion as trade name of Asahi glass Co., Ltd. or the like.

Though the electrolyte membrane in this embodiment is explained based on the perfluorocarbon sulfonic acid resin membrane which is one of solid polymer electrolyte membranes as one kind of proton conductive membranes, an electrolyte membrane to be used in the fuel cell of the present invention is not particularly limited, and it may be one having proton conductivity, or one having another ion conductivity, such as conductivity of hydroxide ion, oxide ion (O²⁻) or the like. The electrolyte membrane with proton conductivity is not limited to the above described solid polymer electrolyte membrane, and it is possible to use: porous electrolyte plates infiltrated with phosphoric acid aqueous solution; proton conductive materials comprising porous glass; phosphoric acid salt glass after hydro-gelation; organic-inorganic hybrid proton conductive membrane which is prepared by introducing functional groups having proton conductivity into a surface and pores of porous glass having nano-sized pores; electrolyte polymer which is reinforced with the use of inorganic metal fibers; or the like. Depending on the structure of the fuel cell, a solid electrolyte membrane which conducts ions to be other charge carriers such as oxygen ion, hydroxide ion and so on may be used, for example, in the case of applying the present invention to a solid oxide fuel cell, a solid polymer type fuel cell which uses hydroxide ion as a charge carrier, or so on.

Each of the electrodes 2 and 3 disposed on the bore side and the shell side of the electrolyte membrane (the perfluorocarbon sulfonic acid resin membrane) maybe formed using materials of the electrode for the solid polymer type fuel cell. The electrode to be used is generally composed by laying a catalyst layer and a gas diffusion layer in this order from an electrolyte membrane side.

The catalyst layer contains catalyst particles, and may further contain a proton conductive material in order to improve a utilizing efficiency of the catalyst particles. Materials used as the electrolyte membrane can also be used as the proton conductive material. As to the catalyst particle, preferably used is a catalyst particle in which a catalyst substance is carried on a conductive material such as carbonaceous material, for example, carbonaceous particles or carbonaceous fibers. Since the fuel cell of the present invention has the hollow-shaped cell module, it can have a large electrode area per unit volume in comparison with a fuel cell having the plane type cell units. Therefore, even if a catalyst to be used is a catalyst having a catalyst activity not as high as that of platinum, a fuel cell having a high power density per unit volume can be obtained. The catalyst substance is not particularly limited, provided that it has a catalyst activity effective to the oxidation reaction of hydrogen in the anode or the reduction reaction of oxygen in the cathode. For example, it can be selected from metals such as platinum (Pt), ruthenium (Ru), iridium (Ir), rhodium (Rh), palladium (Pd), osmium (Os),tungsten (W), lead (Pb), iron (Fe), chromium (Cr), cobalt (Co), nickel (Ni), manganese (Mn), vanadium (V), molybdenum (Mo), gallium (Ga), aluminum (Al); or alloys based on these metals. Preferable is Pt and alloys containing Pt and another metal such as Ru.

As the gas diffusion layer, a porous conductive material containing, as a major component, a carbonaceous material such as carbonaceous particles and/or carbonaceous fibers can be used. The size of the carbonaceous particles and carbonaceous fibers may be optimally selected in consideration of the dispersivity in a solution for producing the gas diffusion layer, the drainability of the gas diffusion layer to be obtained or the like. In order to improve the drainability for water such as the generated water, the gas diffusion layer is preferably subject to a water repellent treatment in such manner that: the gas diffusion layer is infiltrate with any material, such as polytetrafluoroethylene, polyvinylidene fluoride (PVDF), polytetrafluoroethylene, perfluorocarbon alkoxylalkane, ethylene-tetrafluoroethylene polymer, or mixtures based on them, or the like; or a water repellent layer is formed with the use of the materials mentioned above.

As to a structure, materials of the electrode, each of the electrodes disposed on the bore and the shell sides of the hollow electrolyte membrane may be the same or different from each other.

Methods to provide a pair of electrodes on the bore side and the shell side of the tubular electrolyte membrane are not particularly limited. For example, a method may be as follows: a tubular electrolyte membrane is provided (methods to produce the tubular electrolyte membrane are not particularly limited, and a commercial product of a tubular form electrolyte membrane can also be used); a solution containing an electrolyte and catalyst particles is applied to the bore side and the shell side of the tubular electrolyte membrane and dried the same to form catalyst layers; and a solution containing carbonaceous particles and/or carbonaceous fibers is applied to both catalyst layers and dried the same to form the gas diffusion layer. In this method, the catalyst layer and the gas diffusion layer are formed so as to allow a hollow portion to be present at an inner side of the gas diffusion layer formed on the bore side of the electrolyte membrane.

Alternatively, a method may also be as follows: a member (a tubular carbonaceous material) which contains a carbonaceous material such as the carbonaceous particles and/or carbonaceous fibers and is formed into a tubular form is used as a gas diffusion layer of a bore side electrode (the anode); a solution containing an electrolyte and catalyst particles is applied to the shell side of the gas diffusion layer and dried the same to form a catalyst layer of a bore side electrode, thereby a bore side electrode is produced; next, a solution containing an electrolyte is applied to the shell side of the catalyst layer and dried the same to form an electrolyte membrane layer; further, a catalyst layer of a shell side electrode (the cathode) is formed on the shell side of the electrolyte membrane layer; a solution containing a carbonaceous material is applied to the shell side of the catalyst layer and dried the same to form a gas diffusion layer of a shell side electrode. The tubular carbonaceous material may also be obtained in such manner that: a carbonaceous material such as carbonaceous particles and an epoxy based and/or a phenol based resin are dispersed in a solvent; it is formed into a tubular form and then thermally hardened; thereafter, it is baked.

Solvents to be used for forming the electrolyte membrane, the catalyst layer and the gas diffusion layer may be properly selected in accordance with materials to be dispersed and/or dissolved. Also, coating methods for forming each layer may be properly selected from various methods such as spray coating, screen printing or the like.

The cell module having the tubular form to be used in the fuel cell of the present invention is not limited to the structures exemplified above, and it may be provided with any layer other than the catalyst layer and the gas diffusion layer for the purpose of improving functions of the cell module. Though the hollow electrolyte membrane of this embodiment is provided with the anode on the bore side and the cathode on the shell side, it may be provided with a cathode on the bore side and an anode on the shell side.

The current collector for negative electrode 4 (in this embodiment, it is an inner current collector disposed on the surface of the bore side electrode) is a pillar current collector with an outside diameter being in contact with an inner circumferential surface of the cell module. On an outer circumferential surface thereof, the groove 4a which extends along the axial (the longitudinal) direction of the cell module is formed. A gap between the groove and the bore side electrode 2 will be a gas passage inside the hollow to supply hydrogen gas. As the groove 4a, at least one groove which extends along the axial (the longitudinal) direction of the cell module is necessary, and a groove of various patterns or directions will be formed on the outer circumferential surface of the cell module as needed.

A net of the metal wire 5a, which is a part of the current collector for positive electrode 5 (in this embodiment, it is an outer current collector disposed on the surface of the shell side electrode), can be produced by placing the cell module and the rod-like current collector 5b alternately in parallel and winding the metal wire 5a around them as if to knit a net to cover the outer circumferential surfaces thereof.

A metal to be preferably used for the current collector for positive or negative electrode may be at least one kind of metals selected from Al, Cu, Fe, Ni, Cr, Ta, Ti, Zr, Sm, In or the like, or may be alloys based on these metals such as stainless steel. A surface thereof may further be coated with Au, Pt, a conductive resin or the like. In the view point of excellent corrosion resistance, stainless or titanium is preferable among them. A gauge and knitting density of the wire, a diameter of the rod-like current collector or the like is not particularly limited.

Though this embodiment uses the pillar current collector 4 and the current collector 5 comprising the metal wire 5a and the rod-like current collector 5b, the current collectors 4 and 5 may not be particularly limited, and shapes are optional provided that it is made of an electroconductive material. Accordingly, it may be linear or cylindric other than pillar, wire-shaped and rod-like. For example, one formed of a spring-like metal wire or a sheet-like material such as metal foil, metal sheet or carbon sheet may be employed.

The current collector may be fixed on the electrode by a conductive adhesive such as carbon based adhesive, Ag paste or the like, if needed.

<Cell Module Assembly and Fuel Cell>

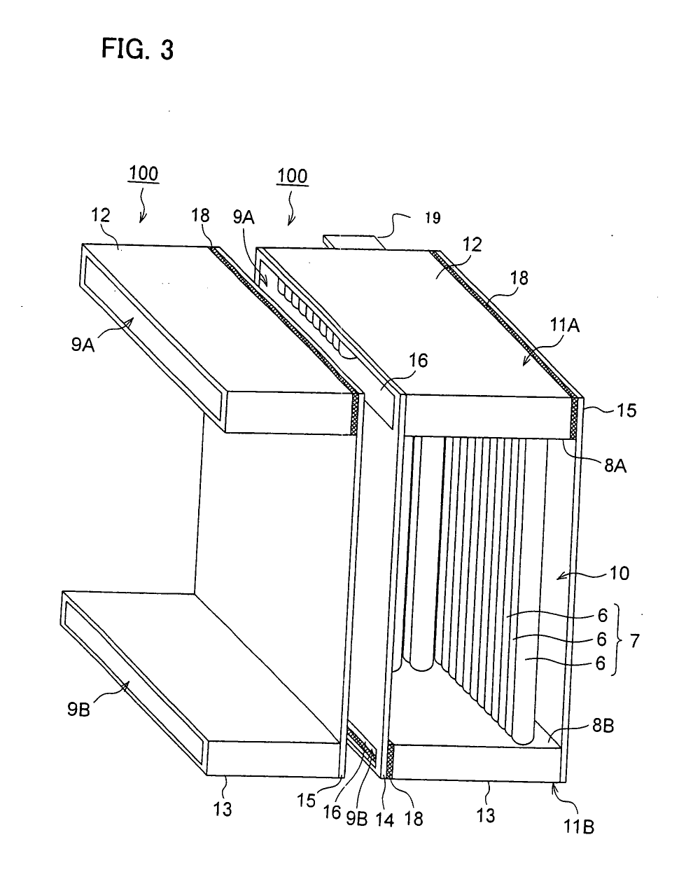

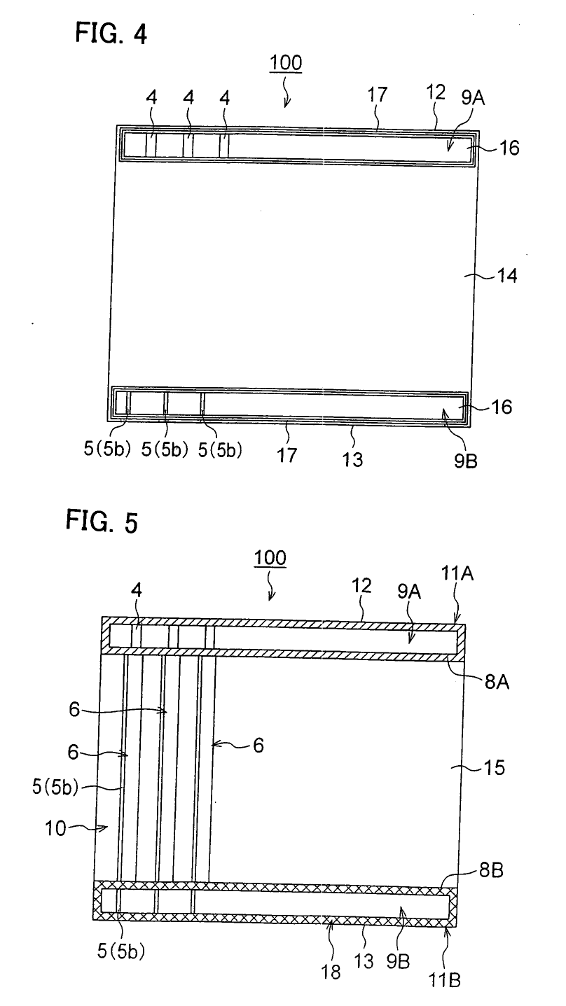

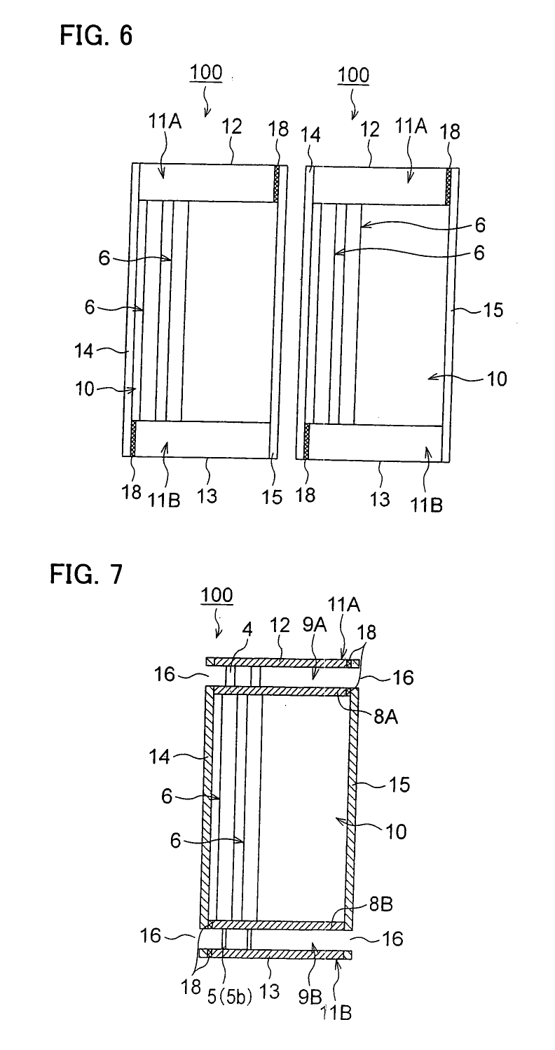

The fuel cell of the present invention is provided with two or more cell module assemblies, each of which has two or more of the above-mentioned cell modules aligned, integrally fixed and gathered. The cell module assembly in the present invention will be described in detail hereafter with reference to FIGS. 3 to 7. FIG. 3 is a view showing one embodiment of the fuel cell of the present invention, which is a perspective view of two adjacent cell module assemblies. FIG. 4 is a view in which the cell module assembly shown in FIG. 3 is observed from a front face side which has a large width (from the negative electrode output 14 side). FIG. 5 is a view in which the cell module assembly shown in FIG. 3, in which the negative electrode output 14 is removed therefrom, is observed from a front face side which has a large width. FIG. 6 is a view in which two adjacent cell module assemblies shown in FIG. 3 are observed from a side face side which has a small width. FIG. 7 is a sectional view of the cell module assembly shown in FIG. 3 along a plane parallel to a side face which has a small width. For the sake of simplicity, some details of the structure are omitted in FIGS. 3 to 7.

In the fuel cell of the embodiment shown in figures, whole surface of the contacting surface between one cell module assembly 100 and an adjacent cell module assembly 100 (except a connecting portion of bore side gas passages 9A or 9B) is a negative output 14 or a positive output 15, which is an electrical contact point between the adjacent cell module assemblies 100. In this way, in each cell module assembly 100 in the fuel cell of the present invention, the positive output 15 or the negative output 14, which is an electrical contacting point between the adjacent cell module assemblies connected in series, is provided on the contacting surface with the adjacent cell module assemblies. More specifically, in each cell module assembly 100, the positive electrode output 15 of the cell module assembly provided on one contacting surface with one adjacent cell module assembly is electrically connected with the negative electrode output 14 of the adjacent cell module assembly on the contacting surface; and the negative electrode output 14 of the cell module assembly provided on the other contacting surface with the other adjacent cell module assembly is electrically connected with the positive electrode output 15 of the other adjacent cell module assembly on the other contacting surface.

Also, in each cell module assembly 100, the current collector for negative electrode 12, which integrally collects power from the current collector for negative electrodes 4 of the cell modules 6, is provided in the vicinity of one end of cell modules 6. A current collector for positive electrode 13, which integrally collects power from the current collector for positive electrodes 5, is provided in the vicinity of the other end of cell modules 6. Further, cell module assemblies 100 are aligned keeping the current collector for negative electrode 12 and the current collector for positive electrode 13 to the same direction. More specifically, the negative electrode output 14 and the positive electrode output 15 have a large area so that the negative electrode output 14 which connects with the current collector for negative electrode 12 disposed at one end of cell modules 6 in each cell module assembly 100 is brought into contact with the positive electrode output 15 which connects with the current collector for positive electrode 13 disposed at the other end of cell modules 6 at a contacting surface with an adjacent cell module assembly 100.

As described above, since plurality of cell module assemblies 100 are electrically connected with each other on a contacting surface with adjacent cell module assemblies 100, the fuel cell of the present invention has a simple structure connecting cell module assemblies and no longer needs much space for electrical connection. Also, it is excellent in conduction between cell module assemblies since an area of the positive electrode output 14 or the negative electrode output 15, which is an electrical contact point between adjacent cell module assemblies, can be enlarged. Thus, the fuel cell of the present invention enables to obtain a large current. Further, since a series connection can be accomplished aligning the direction of each cell module assembly 100 to the same direction, even in the case of using a dead-end type cell module, it is not necessary to produce two kinds of cell module assemblies having opposite position of positive electrode and negative electrode or to provide complicated gas passages. Therefore, according to the present invention, it is possible to reduce the number of members necessary for fuel cell assembly.

Hereinafter, the cell module assembly of the present invention will be described in detail.

In the cell module assembly 100 shown in FIGS. 3 to 7, two or more cell modules 6 are aligned keeping the longitudinal direction of each cell module in parallel and open ends (an open end in which the current collector for negative electrode 4 is exposed and an open end in which the current collector for positive electrode 5 is exposed) to the same direction so as to form a cell module array 7.

Plurality of cell modules 6 contained in the cell module array are aligned keeping a predetermined distance, that is, at regular distance intervals, and usually they are aligned at regular (equal) intervals. If they are not aligned at equal intervals, a flow of reactant gas, which flows between the cell modules to be supplied to a shell side electrode 3 of the cell module, becomes uneven so that the quantity of reactant gas supplied to each cell module varies and power generation efficiency of the fuel cell may deteriorate. In particular, when intervals between the cell modules perpendicular to the direction in which reactant gas to be supplied to the shell side of the cell modules flows are not regular, large unevenness is likely to occur in the flow of reactant gas. Thus, it is preferable to align the cell modules so as to at least maintain regular intervals between the cell modules perpendicular to the direction in which reactant gas to be supplied to the shell side of the cell modules flows. As long as there are regular intervals between the cell modules, the cell modules may be attached together and aligned in other directions. In addition, intervals between the cell modules perpendicular to the direction in which reactant gas to be supplied to the shell side of the cell modules flows and intervals between the cell modules in other directions may not be the same. Herein, FIGS. 3 to 7 show a part of the cell module array 7.

On two open end sides of each cell module 6 in the cell module array 7, a bore side gas passage 9 (9A, 9B) to circulate a reactant gas (in this embodiment, it is a hydrogen gas) into the bore side of each cell module 6 is provided. Also, on the body side of each cell module 6 in the cell module array 7, a shell side gas passage 10 to circulate a reactant gas (in this embodiment, it is air) on the shell side of each cell module 6 is provided. Gas sealing properties of the two bore side gas passages 9A and 9B, and the shell side gas passage 10 are ensured by a partition 8 (8A, 8B), which separates a space outside of the cell module 6 between the two open ends and the body of the cell module 6 in the cell module array 7.

One of the bore side gas passages 9A and 9B is a supply passage (upstream) to supply a hydrogen gas into a hollow of the cell module and the other is an exhaust passage (downstream) to exhaust the hydrogen gas (an unreacted hydrogen gas of which hydrogen is partially consumed) from the hollow. The difference in gas pressure determines, among 9A and 9B, which is upstream or downstream. One open end of the cell module 6 is connected with the supply passage of the bore side gas passage 9 and the other open end is connected to the exhaust passage of the bore side gas passage 9 so as to run a hydrogen gas into the hollow. As shown in FIG. 3, the two open ends of each cell module 6 are respectively inserted in a through hole (not shown) provided to the partition 8 and connected to the bore side gas passage 9 respectively.

Herein, the open end may not penetrate the partition 8 and may be arranged, for example, to allow a tip thereof to touch a face of the partition 8, which is to be the inner surface of the bore side reactant gas passage 9. Alternatively, it may be arranged in such a manner that: the tip of the open end is fixed in the through hole; a fixing structure capable of adjusting the position of the axial direction of each cell module 6 is provided; and the tip is arranged to be in the through hole by the fixing structure. Alternatively, only the current collector for negative electrode 4 or the rod-like current collector 5b, which is a part of the current collector for positive electrode 5, may penetrate (see FIGS. 5 to 7).

It is preferable that the through holes provided to the partition 8 have an inside diameter which allows to insert each cell module 6 and are arranged at a predetermined distance. The partition having such through holes functions as a means for positioning, which is capable of automatically determining the position of each cell module 6, so that the cell modules can be aligned efficiently. As mentioned above, it is preferable that the cell modules 6 in the cell module array 7 are aligned at a predetermined distance, generally at regular (even) intervals, and that the cell modules perpendicular to the direction in which reactant gas to be supplied to the shell side of the cell modules flows are aligned so as to at least maintain regular intervals therebetween. Consequently, even it depends on the direction in which reactant gas to be supplied to the shell side of the cell modules flows, the through holes provided to the partition 8 are preferably arranged at equal intervals so as to maintain regular intervals between the cell modules. The length of the intervals may be a length in which the shell side of the cell module can be supplied with a sufficient amount of reactant gas, and it may be accordingly determined.

Each cell module 6 inserted in a through hole of the partition 8 is generally fixed with respect to the through hole by a potting treatment or the like. Herein, in order to prevent a potting material from flowing to a surface opposite to the surface on which potting treatment is performed, a through hole provided to the partition 8 preferably has an inside diameter approximately equal to the outside diameter of the cell module to be inserted in the through hole (in the case of inserting a cell module with a current collector of the shell side electrode, it is an outside diameter including the current collector).

In the embodiment, the bore side gas passages 9A and 9B are respectively formed with tubular body portions 11A and 11B, which are each made of a conductive material and integrated with the partition 8 and the current collector for negative electrode 12 or the current collector for positive electrode 13 respectively. The tubular body portion 11 (11A and 11B) is open on a contacting surface side with an adjacent cell module assembly 100. The negative electrode output 14 and the positive electrode output 15 disposed to the contacting surface are also provided with an opening 16, which is attached to that of the tubular body portion 11. The bore side gas passages 9 of adjacent cell module assemblies 100 are connected and communicated with each other at the opening 16 (a flow channel connecting portion) provided to the negative electrode output 14 and the positive electrode output 15 of each cell module assembly 100. Herein, it is preferable to generally provide a gas sealing material such as o-ring 17 on a periphery of the flow channel connecting portion for increasing gas sealing properties of the flow channel connecting portion (the opening 16) of the adjacent cell module assemblies 100.

As described above, in the case of employing a structure to communicate gas passages of adjacent cell module assemblies 100 with each other, it is generally hard to enlarge a contacting area between the adjacent cell module assemblies since a connecting portion of the bore side gas passages or a gas sealing material is present in the vicinity of the current collector for positive and/or negative electrode. In contrast, in the fuel cell of the present invention, a contacting surface between adjacent cell module assemblies including areas far from the current collector for positive and/or negative electrode can be fully used as the positive and/or negative electrode output; thus, it is possible to enlarge a contacting area of the negative electrode output 14 and the positive electrode output 15 in contact. Therefore, even though a connecting portion of gas passages or a gas sealing material (for example, an o-ring) is disposed to the contacting surface, a sufficiently large contacting area to be an electrical contact point between adjacent cell module assemblies can be obtained.

In the cell module assembly 100 shown in FIG. 3, the shell side gas passage 10 positioned between the two partitions 8A and 8B facing each other can supply and exhaust a reactant gas to/from a side face having a small width of the cell module assembly 100. In the cell module assembly 100 shown in FIG. 3, since a connecting surface of an adjacent cell module assembly is the plate-like output 14 or 15, a reactant gas is supplied and exhausted to/from a side face having a small width in this way. However, an opening to be a connecting portion of the shell side gas passage 100 of each cell module assembly 100 may be provided to a contacting surface with the adjacent cell module assembly to communicate with a shell side gas passage of the adjacent cell module assembly.

Also, in the embodiment, air is used as a reactant gas to be supplied to the shell side of the cell module 6. Accordingly, the shell side gas passage 10 may be an open space to allow air to flow freely to/from the outside of the cell module assembly 100 or a closed space communicated with an air supply source and an exhaust passage.

The partition 8 forms the bore side gas passages 9A and 9B, and constitutes a part of the tubular body portion 11 which functions as the current collector for negative electrode 12 or the current collector for positive electrode 13. However, it may be a structure that the partition 8 is integrated with other members constituting the cell module assembly 100 or a structure that the partition 8 is removable from the tubular body portion 11.

Also, in the embodiment, the partition 8 constitutes a part of the tubular body portion 11 and is made of a conductive material. However, a material to form the partition 8 is not particularly limited and it may be one having sufficient hardness or strength to support the cell module 6 and non-permeability with respect to a reactant gas. For example, there may be metal, resin, carbon material, glass, ceramics and so on. In the case of forming the partition 8 with a conductive material, insulation against other members including the cell module 6 is applied thereto as needed.

Structures of the negative electrode output 14 and the positive electrode output 15 are not particularly limited if they are disposed to the contacting surface between adjacent cell module assemblies. For example, it may be a structure that one end is connected with the current collector for negative electrode 12 or the current collector for positive electrode 13 while the other end is not fixed at any members. Alternatively, it may be a structure that the negative electrode output 14 or the positive electrode output 15 is provided to the connecting surface and connected with the current collector for negative electrode 12 or the current collector for positive electrode 13 respectively while a part of a plate-like member to reinforce the cell module 6 in the cell module array 7 is formed of a conductive material. Also, a shape thereof is not particularly limited.

From the viewpoint of electrical connection between adjacent cell module assemblies, a contacting area of outputs to be an electrical contact point is more preferable as the contacting area is further enlarged. Also, as in the embodiment, it is preferable that, in each cell module assembly 100, the negative electrode output 14 and/or the positive electrode output 15 constitutes a pillar structure which bridges upper and lower ends of a contacting surface with the adjacent cell module assembly 100. If the negative electrode output 14 and/or the positive electrode output 15 has such a pillar structure, a contacting area of outputs of the adjacent cell module assemblies 100 can be enlarged and also the cell module array 7 can be reinforced in the axial direction.

A pillar structure of each output is not limited to a planar one such as a plate shown in figures which spreads all over a contacting surface as far as it bridges upper and lower ends of the contacting surface with the adjacent cell module assembly 100. For example, it may be one having a small width with respect to the horizontal direction of a contacting surface or one having plurality of such pillar structures having a small width. In order to reduce the weight of the cell module assembly 100, a penetration structure such as punched holes may be formed in the plate-like one shown in figures.

For reasons that a large current can be obtained since a contacting area of the negative electrode output 14 and the positive electrode output 15 of adjacent cell module assemblies 100 is large and the reinforcing effect on each cell module 6 forming the cell module array 7 is large, it is preferable that the negative electrode output 14 and the positive electrode output 15 are in a plate-like form to form a whole contacting surface with the adjacent cell module assembly 100 as in this embodiment.

When using the negative electrode output 14 and/or the positive electrode output 15 in such a pillar structure, it is necessary to electrically insulate a part at which the electrode output and a current collector of the opposite pole are fixed. In the embodiment, the negative electrode output 14 connecting with the current collector for negative electrode 12 provided to the upper end of each cell module assembly 100 is connected with the current collector for positive electrode 13 provided to the lower end of the cell module assembly 100 through an insulating material 18. Similarly, the positive electrode output 15 connecting with the current collector for positive electrode 13 provided to the lower end of the cell module assembly 100 is connected with the current collector for negative electrode 12 provided to the upper end of the cell module assembly 100 through the insulating material 18. The insulating material 18 is arranged to surround a periphery of the opening on the negative electrode output 14 side of the tubular body portion 11B which functions as the current collector for positive electrode 13 and a periphery of the opening on the positive electrode output 15 side of the tubular body portion 11A which functions as the current collector for negative electrode 12.

The insulating material 18 is not particularly limited as far as it is able to electrically insulate between the negative electrode output 14 and the current collector for positive electrode 13 and between the positive electrode output 15 and the current collector for negative electrode 12. For example, an insulating adhesive capable of connecting and insulating between the negative electrode output 14 and the tubular body portion 11B which functions as the current collector for positive electrode 13 and between the positive electrode output 15 and the tubular body portion 11A which functions as the current collector for negative electrode 12 or the like may be used. Specifically, there may be epoxy-based adhesives, silicone-based adhesives and so on.

A conductive material which forms each electrode output 14 or 15 and each current collector 12 or 13 may not be particularly limited. For example, there may be metal, carbon material, conductive ceramics, a conductive resin and so on. Such conductive materials may be used alone or in combination. As a specific metal material, for example, there may be one or more kinds of metal selected from Al, Cu, Fe, Ni, Cr, Ta, Ti, Zr, Sm, In or the like, or alloys based on these metals such as stainless steel (SUS). A conductive material forming the outputs and the current collectors may be optimally selected in accordance with the structure of the cell module assembly. In terms of strength, SUS or Ti is preferable. In terms of reduction in weight, Al or Ti is preferable. In terms of conductivity, Cu or Al is preferable. Also, it may be optimally selected in accordance with the environment to which each current collector or output is exposed. For example, when contacting with hydrogen, one which is resistant to hydrogen embrittlement, which is a phenomenon that a metallic material is embrittled by absorbing hydrogen, may be preferably selected. When resistance to corrosion is required, Ti, SUS or so on may be preferably used.

Hereinafter, an electric connection between the current collector for negative electrode 12 or the current collector for positive electrode 13 and the current collector for negative electrode 4 or the current collector for positive electrode 5 of each cell module 6 will be explained.

At the upper end of the cell module 6 disposed with the current collector for negative electrode 12, the current collector for negative electrode 4, which is extended from the open end of each cell module 6 inserted in a through hole of the partition 8A, gets across the bore side gas passage 9A and is connected with the current collector for negative electrode 12. On the other hand, at the lower end of the cell module 6 disposed with the current collector for positive electrode 13, the current collector for positive electrode 5, which is extended from the open end of each cell module 6 inserted in a through hole of the partition BB, gets across the bore side gas passage 9B and is connected with the current collector for positive electrode 13.

Herein, a method for connecting the current collector for negative electrode 12 with the current collector for negative electrode 4 or a method for connecting the current collector for positive electrode 13 with the current collector for positive electrode 5 is not particularly limited. For example, there may be a method in such a manner that: each current collector (12, 13) is provided with a through or non-through hole in which a current collector (4, 5) can be inserted; the current collector (4, 5) of each cell module 6 is inserted in the hole and fixed with a solder or the like so as to connect each current collector (12, 13) with the current collector (4, 5). When providing the current collector with such a through hole, the hole is closed as needed to ensure gas sealing properties of the bore side gas passage.

In the embodiment, the tubular body portion 11A or 11B which forms the bore side gas passage 9A or 9B is made of a conductive material and works also as the current collector for negative electrode 12 or the current collector for positive electrode 13. However, there is no particular limitation to the position or structure of the current collector for negative electrode 12 or the current collector for positive electrode 13 as far as the current collector for negative electrode 12 is provided in the vicinity of one end of the cell module 6 in the cell module array 7 and the current collector for positive electrode 13 is provided in the vicinity of the other end. For example, the current collector for negative electrode 12 and/or the current collector for positive electrode 13 may constitute a part of the bore side or the shell side of bore side gas passage 9A or 9B, or may be disposed on the bore side or shell side of the bore side gas passage 9A or 9B.

A method for electrically connecting the current collector for negative electrode 12 which integrally collects power from the current collector for negative electrodes 4 of each cell module 6 with the negative electrode output 14 and a method for electrically connecting the current collector for positive electrode 13 which integrally collects power from the current collector for positive electrodes 5 of each cell module 6 with the positive electrode output 15 are not particularly limited. In the embodiment, the tubular body portion 11A which is made of a conductive material and functions as the current collector for negative electrode 12 is welded and electrically connected to the negative electrode output 14 made of a conductive material. However, it may be a structure that the tubular body portion 11A and the negative electrode output 14 are integrally molded. Similarly, in the embodiment, the tubular body portion 11B which is made of a conductive material and functions as the current collector for positive electrode 13 is welded and electrically connected to the positive electrode output 15 made of a conductive material. However, it may be a structure that the tubular body portion 11B and the positive electrode output 15 are integrally molded.

Among plurality of cell module assemblies connected in series, generally, the current collector for negative electrode 12 of the cell module assembly disposed to one end is provided with the output terminal 19 to conduct to the outside of the fuel cell. The current collector for positive electrode 13 of the cell module assembly disposed to the other end is provided with an output terminal (not shown) to conduct to the outside of the fuel cell.

The cell module assembly of the present invention is not limited to the shapes shown in FIGS. 3 to 7. The number of cell modules constituting one cell module assembly, the alignment of the cell modules and so on are also not particularly limited. For example, in FIGS. 3 to 7, the current collector for negative electrode 12 is disposed to the upper end side of the cell module assembly 100 and the current collector for positive electrode 13 is disposed to the lower end side of the cell module assembly 100; however, they may have the opposite structure.

Also, in the embodiment, the cell module of which hollow is open at both ends is used so that the bore side gas passage 9 (9A and 9B) comprising a supply passage and an exhaust passage is connected with each of the open ends of the cell module. However, in the case of a dead-end type cell module, of which hollow is opened at only one end, a cell module array, in which open ends and closed ends of the cell modules are each kept to the same direction and aligned, is formed. In this case, the bore side gas passage comprises only a supply passage to supply a reactant gas from the open end into the hollow so that the supply passage is connected with the open end. It is not necessary to provide the partition 8 on the closed end side of the cell module and it is only necessary to be secured to a member for fixing the cell module having no bore side gas passage. The fixing member is preferably provided with a guiding means to determine the position of the cell module in the cell module array such as holes, grooves or the like provided at a predetermined distance. The fixing member may also function as the current collector.

### INDUSTRIAL APPLICABILITY

As aforementioned, in the area of the solid polymer electrolyte fuel cell being easy in size reduction and operative at a low temperature, the fuel cell of the present invention is useful as a fuel cell which attains further improvement in power generating capacity and a longer life. Particularly, it is suitable for application to power sources for portable or movable articles.

1. A fuel cell comprising two or more cell module assemblies attached and connected in series, each of which gathers two or more cell modules, the cell module, having at least one end open, comprising a hollow electrolyte membrane, a pair of electrodes disposed on a bore side and a shell side of the hollow electrolyte membrane and current collectors being in contact with the electrodes in the pair respectively,
wherein each cell module assembly comprises: a cell module array in which two or more cell modules are aligned keeping the longitudinal direction of each cell module in parallel and open ends or closed ends to the same direction; a partition which separates a space outside of the cell module between the open end and a body of the cell module in the cell module array; a bore side gas passage provided on the open end side of the cell module in the cell module array by said partition and connected with each open end of the cell module so that the bore side gas passage circulates a reactant gas into the bore side of each cell module; a shell side gas passage provided on the body side of the cell module in the cell module array by said partition so that the shell side gas passage circulates a reactant gas on the shell side of each cell module; a current collector for positive electrode provided in the vicinity of one end of the cell module in the cell module array so that the current collector for positive electrode integrally collects power from each current collector on the positive electrode side of each cell module, and a current collector for negative electrode provided in the vicinity of the other end so that the current collector for negative electrode integrally collects power from each current collector on the negative electrode side of each cell module; and a positive or negative electrode output connected with the current collector for positive or negative electrode and provided on a contacting surface of an adjacent cell module assembly; and
wherein the cell module assemblies are attached having the current collector of the same pole in the same direction, in which, as for adjacent cell module assemblies, the positive electrode output is arranged on the contacting surface of one cell module assembly and the negative electrode output is arranged on the contacting surface of the other cell module assembly, and the cell module assemblies are connected in series.

2. A fuel cell according to claim 1, wherein each cell module assembly has a flow channel connecting portion which is an opening on the contacting surface with the adjacent cell module assembly, and the flow channel connecting portion connects with that of the adjacent cell module assembly to allow bore side gas passages of cell module assemblies to communicate.

3. A fuel cell according to claim 2, wherein a gas sealing material is disposed on a periphery of the flow channel connecting portion.

4. A fuel cell according to claim 3, wherein the gas sealing material is an o-ring.

5. A fuel cell according to claim 1, wherein the positive and/or negative electrode output of each cell module assembly constitutes a pillar structure which bridges an upper end and a lower end of the contacting surface with the adjacent cell module assembly, and wherein a connecting portion with a current collector of an opposite pole is electrically insulated.

6. A fuel cell according to claim 1, wherein an output terminal for conducting current to/from an outside of the fuel cell is disposed at the positive or negative electrode output of a cell module assembly in an end position of the cell module assemblies connected in series.
